(19) United States
(12) Patent Application Publication
(10) Pub. No.: US 2015/0248529 A1
(43) Pub. Date: Sep. 3, 2015

(54) HEALTHCARE MANAGEMENT SYSTEM

(71) Applicant: Chen Technology, Inc., Miami Gardens, FL (US)

(72) Inventor: James J. Chen, Miami Gardens, FL (US)

(21) Appl. No.: 14/456,702

(22) Filed: Aug. 11, 2014

Related U.S. Application Data
(60) Provisional application No. 61/946,287, filed on Feb. 28, 2014.

(51) Int. Cl. G06F 19/00

(52) U.S. Cl. CPC G06F 19/327; G06F 19/322

(57) ABSTRACT

Systems, methods, and computer-readable media for managing and facilitating the delivery of healthcare services are described. Some embodiments provide a healthcare management system configured to analyze and process healthcare information and healthcare expenditure information. Healthcare information may generally include medical information associated with a healthcare entity, such as a patient, a healthcare professional, a healthcare facility, or the like. Healthcare expenditure information may generally include any information associated with the cost of medical care related to a patient, healthcare professional, a healthcare facility, and/or a medical procedure. The healthcare management system may be configured to generate healthcare assessments based on the healthcare information and/or healthcare expenditure information. In general, a healthcare assessment may include any valuation, estimation, ranking, or the like that may indicate the efficiency of an element of healthcare information and/or a healthcare expenditure information, such as the cost efficiency of a medical claim.

### CROSS REFERENCE TO RELATED APPLICATIONS

This application claims the benefit of U.S. Provisional Application No. 61/946,287 filed on Feb. 28, 2014, the contents of which are incorporated by reference in their entirety as if fully set forth herein.

### BACKGROUND

Healthcare providers have traditionally generated large amounts of information relating to patients, patient care, and the medical professionals delivering treatment. In addition, healthcare providers are maintaining increasing volumes of data relating to the costs associated with administering medical care to patients as a result of increased pressure to control healthcare costs. This information is generally stored in different platforms, such as electronic medical records (EMRs), electronic health records (EHRs), healthcare information and management systems (HIMS), and healthcare cost databases. Thus, healthcare providers are not able to obtain a comprehensive and functional view of a patient's medical history and the costs associated with their treatment. As such, healthcare professionals and facility administrators are attempting to administer healthcare and control expenditures without a complete and accurate analysis of the costs associated with providing medical care. Accordingly, healthcare professionals would be able to provide higher quality care more efficiently and cost effectively if they could base their medical treatment and cost management decisions on a complete examination of the expenditures associated with treating patients.

### SUMMARY

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In an embodiment, a healthcare management system may include a processor and a non-transitory, computer-readable storage medium in operable communication with the processor. The computer-readable storage medium may contain one or more programming instructions that, when executed, cause the processor to access source information from at least one data source, generate healthcare information and healthcare expenditure information from the source information, and generate at least one healthcare assessment based on the healthcare information and the healthcare expenditure information, the healthcare assessment being configured to indicate a cost efficiency of at least one item of healthcare information.

In an embodiment, a computer-implemented method for generating at least one healthcare assessment may include, by a processor, accessing source information from at least one data source, generating healthcare information and healthcare expenditure information from the source information, and generating the at least one healthcare assessment based on the healthcare information and the healthcare expenditure information, the healthcare assessment being configured to indicate a cost efficiency of at least one item of healthcare information.

In an embodiment, a computer-readable storage medium may have computer-readable program code configured to generate at least one healthcare assessment embodied therewith. The computer-readable program code may include computer-readable program code configured to access source information from at least one data source, computer-readable program code configured to generate healthcare information and healthcare expenditure information from the source information, and computer-readable program code configured to generate at least one healthcare assessment based on the healthcare information and the healthcare expenditure information, the healthcare assessment being configured to indicate a cost efficiency of at least one item of healthcare information.

### BRIEF DESCRIPTION OF THE DRAWINGS

The above and other objects of the present invention will become more readily apparent from the following detailed description taken in connection with the accompanying drawings.

FIG. 1 depicts an illustrative healthcare management system according to a first embodiment.

FIG. 2 depicts an illustrative healthcare management system according to a second embodiment.

FIG. 3 FIG. 3 depicts an illustrative financial information graphical user interface (GUI) for a patient according to some embodiments

FIG. 4 depicts an illustrative claim cost information GUI according to some embodiments.

FIG. 5 depicts an illustrative trend GUI according to some embodiments

FIG. 6 depicts a polar chart of efficiency information according to an embodiment.

FIG. 7 illustrates various embodiments of a computing device for implementing the various methods and processes described herein.

### DETAILED DESCRIPTION

The present disclosure generally relates to systems, methods and non-transitory computer-readable media for managing and facilitating the delivery of healthcare services. In particular, some embodiments provide a healthcare management system configured to analyze, examine, search, investigate, consider, evaluate, and/or otherwise process healthcare information and healthcare expenditure information and to generate various healthcare assessments based on the healthcare information and healthcare expenditure information. Healthcare information may generally include medical information associated with a healthcare entity, such as a patient, a healthcare professional, a healthcare facility, or the like. Non-limiting examples of healthcare information may include, without limitation, age, gender, weight, height, medications, surgeries and other medical procedures (for example, diagnostic tests, diagnostic imaging tests, or the like), occupation, past and current medical conditions, family history, patient description of health condition, healthcare professional description of health condition, symptoms, medical survey information, medical claims, medical scores (for example, Centers for Medicare and Medicaid (CMS) hierarchical condition categories (HCC) scores), healthcare professional information, primary care physician (PCP), health insurance information, health care facility information, or the like. Healthcare expenditure information may generally include any information associated with the cost of medical care related to a patient, healthcare professional (for instance, a medical doctor), a healthcare facility, and/or a medical procedure. A healthcare assessment may generally include any valuation, appraisal, evaluation, estimation, ranking, measurement, and/or other calculation configured to indicate the efficiency of an element of healthcare information and/or a healthcare expenditure information. For example, a healthcare assessment may be configured to indicate the cost efficiency of a medical claim.

The healthcare management system does not automatically provide medical advice, assistance, instructions, or other guidance to patients and/or patient caregivers. As configured according to some embodiments described herein, the healthcare management system provides information to facilitate efficient access to information and to transform existing healthcare information into a medical assessment that may be used by a healthcare provider and/or a healthcare administrator to manage the delivery of healthcare to patients.

The healthcare management system configured according to some embodiments described herein provides multiple technological advantages. One non-limiting technological advantage is that the healthcare management system may provide a centralized interface for healthcare information and healthcare expenditures. In this manner, a healthcare professional and/or healthcare facility administrator may have access to a comprehensive picture of the medical care delivered to a patient. In addition, a healthcare professional and/or healthcare facility administrator may have access to a complete and functional overview and assessment of the medical costs associated with delivering medical care. Another non-limiting technological advantage is that the healthcare management system is capable of dynamically adapting its analysis processes based on healthcare professional and/or patient feedback, updated cost and treatment information, or the like. In this manner, the healthcare management system is able to provide more accurate, comprehensive and efficient medical cost assessments compared to those available using existing technology.

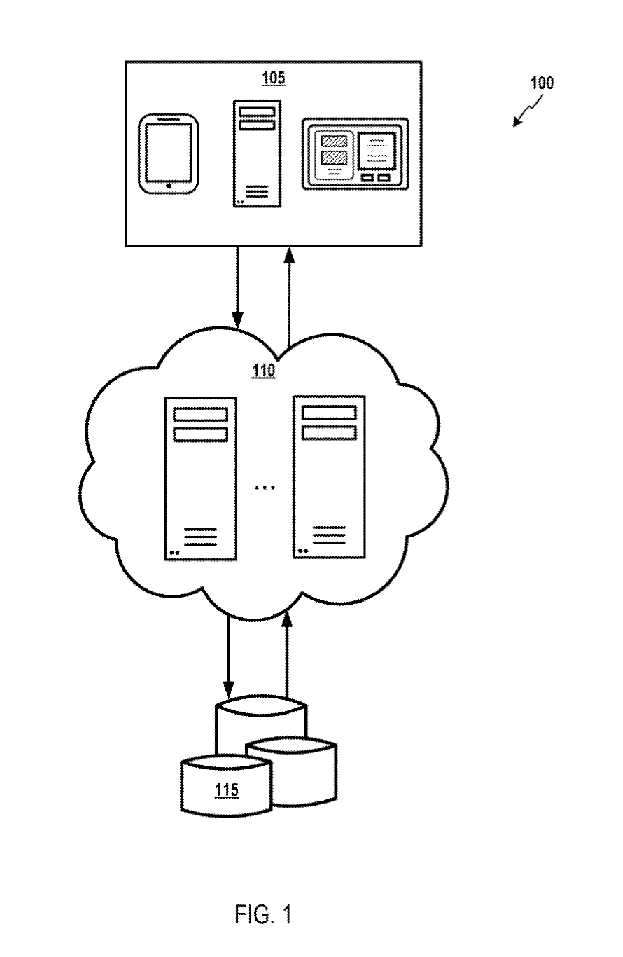

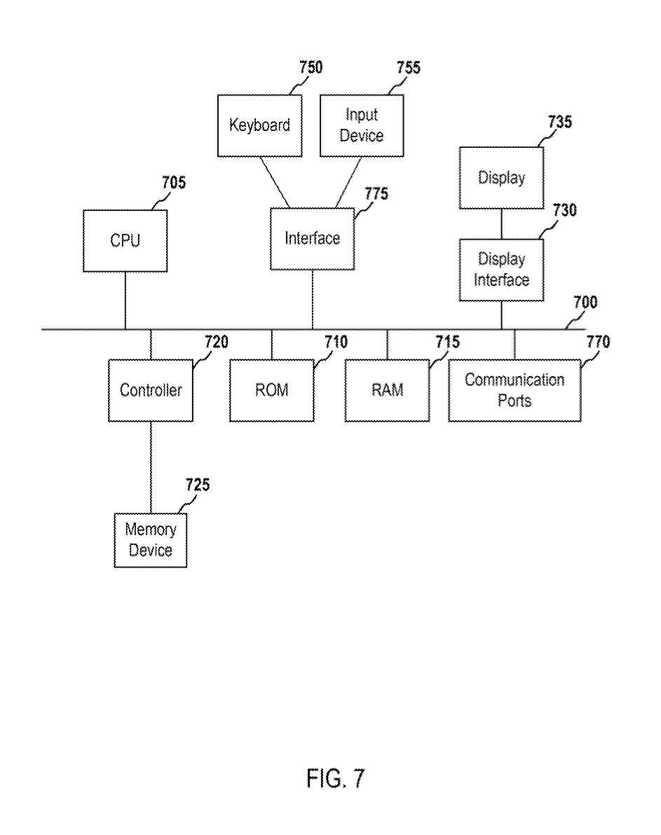

FIG. 1 depicts an illustrative healthcare management system according to a first embodiment. As shown in FIG. 1, the healthcare management system (the “management system”) 100 may include one or more server logic devices 110, which may generally include a processor, a non-transitory memory or other storage device for housing programming instructions, data or information regarding one or more applications, and other hardware, including, for example, the central processing unit (CPU) 705, read only memory (ROM) 710, random access memory (RAM) 715, communication ports 740, controller 720, and/or memory device 725 depicted in FIG. 7 and described below in reference thereto.

In some embodiments, the programming instructions may include a healthcare management application (the “management application”) configured to, among other things, analyze healthcare information and/or healthcare expenditure information and generate healthcare assessments. The server logic devices 110 may be in operable communication with client logic devices 105, including, but not limited to, server computing devices, personal computers (PCs), kiosk computing devices, mobile computing devices, laptop computers, smartphones, personal digital assistants (PDAs), medical equipment, tablet computing devices, or any other logic and/or computing devices now known or developed in the future.

In some embodiments, the management application may be accessible through various platforms, such as a client application, web-based application, over the Internet, and/or a mobile application (for example, a “mobile app” or “app”). According to some embodiments, the management application may be configured to operate on each client logic device 105 and/or to operate on a server computing device accessible to logic devices over a network, such as the Internet. All or some of the files, data and/or processes (for example, healthcare information, healthcare expenditure information, healthcare assessment processes, or the like) used for analysis of healthcare information, healthcare expenditure information, and/or the generation of healthcare assessments may be stored locally on each client logic device 105 and/or stored in a central location and accessible over a network.

In an embodiment, one or more data stores 115 may be accessible by the client logic devices 105 and/or server logic devices 110. The data stores 115 may include healthcare information, healthcare expenditure information, healthcare assessment rules, healthcare assessment processes and/or services, patient information, claim information, healthcare facility information, and/or the like. In some embodiments, at least a portion of the data stores 115 may include information associated with a healthcare information system, including, without limitation, healthcare information and management systems (HIMS), electronic medical record (EMR) systems, radiology information systems (RIS), picture archiving and communications system (PACS), Medicaid Management Information Systems (MMIS), health insurance provider systems, and/or the like. In some embodiments, the data stores 115 may include information obtained from multiple healthcare facilities, healthcare providers, and/or health insurance providers. In some embodiments, at least a portion of the data stores 115 may include a third-party data source, including, without limitation a government healthcare information system (for example, the Centers for Medicare and Medicaid Management (CMS)), a medical library, a third-party medical database, a health insurance provider information system, and/or the like.

Although the one or more data stores 115 are depicted as being separate from the logic devices 105, 110, embodiments are not so limited, as all or some of the one or more data stores may be stored in one or more of the logic devices.

As described in more detail below, the management application may access information and/or processes stored in the data stores 115 to present healthcare information, healthcare expenditure information, and/or to generate healthcare assessments. A healthcare professional may initiate the generation of a healthcare assessment and/or enter healthcare information and/or healthcare expenditure information from a client logic device 105, and the management application may generate a healthcare assessment for presentation on a display component of the client logic device. For instance, the management application may access the healthcare expenditure information associated with a medical claim and generate a healthcare assessment indicating the efficiency of the medical care associated with the medical claim for consideration by the healthcare professional. For example, the management application may graphically represent the cost efficiency associated with the medical claim in relation to similar medical claims for other patients, medical professionals, and/or healthcare facilities. In another example, the management application may provide a complete medical treatment history for a patient, including diagnostic tests, medical claims, treating physicians, medical costs, outcomes, patient survey information, and/or the like associated with a patient. In this manner, a medical professional and/or healthcare facility administrator may have access to the complete medical history associated with a patient, including information from other healthcare facilities.

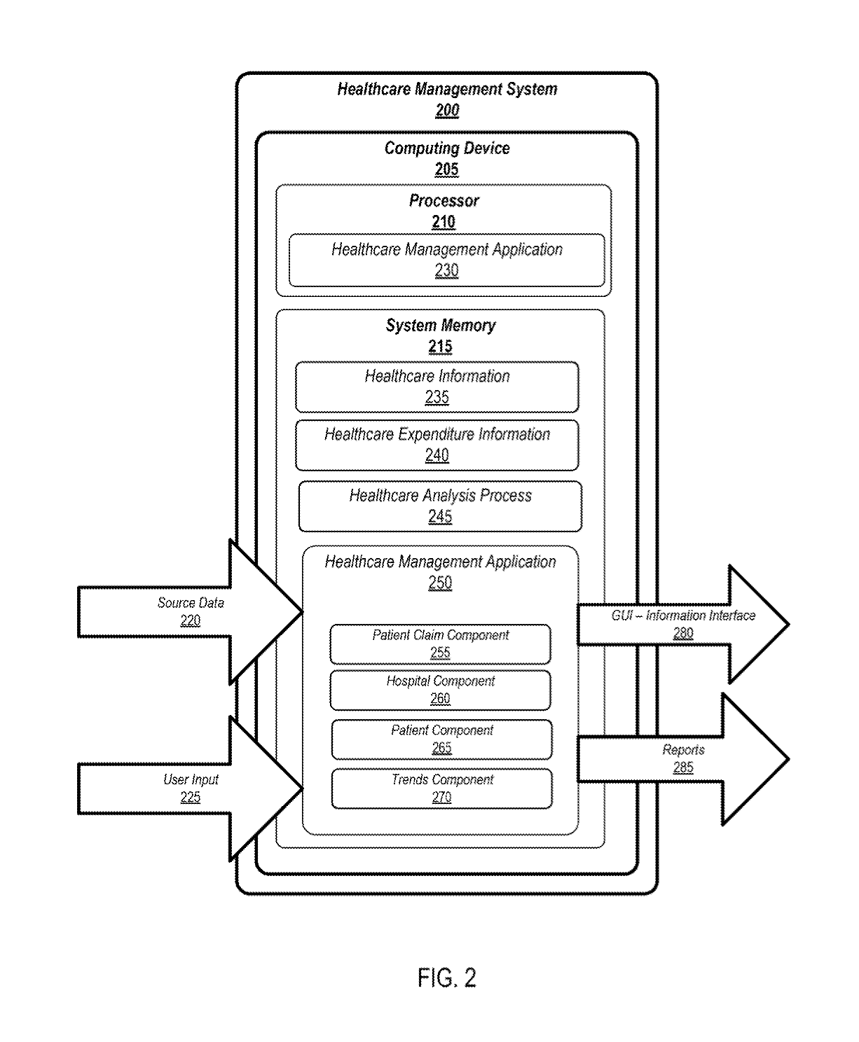

FIG. 2 depicts an illustrative healthcare management system according to a second embodiment. As shown in FIG. 2, a healthcare management system (the “management system”) 200 may include a computing device 205 having a processor 210 and system memory 215. The computing device 205 may include any type of computing device, such as the client logic device 105 and server logic devices 110 described in reference to FIG. 1. The processor 210 may be configured to execute a healthcare management application (the “management application”) 250. The management application 250 may be configured to receive source information 220 and/or user input 225, for instance, through the processor 210 and/or as stored or cached as local healthcare information 295 in the system memory 215.

The source information 220 may include information from any data source accessible by the management system 200, including, without limitation a healthcare information and management systems (HIMS), electronic medical record (EMR) systems, radiology information systems (RIS), picture archiving and communications system (PACS), Medicaid Management Information Systems (MMIS), health insurance provider systems, and/or any other type of data store having healthcare information, a health information library and/or cloud, a third-party database, or the like.

In some embodiments, the source information 220 may include any information associated with a patient, a medical provider, a healthcare facility, a medical procedure, a health insurer, a medical claim system (for example, Medicare, Medicaid, CMS-HCC, health insurance medical claim systems, or the like), or any other source of healthcare information. Non-limiting examples of source information 220 may include any information associated with the physical and/or mental condition of a patient, symptoms, medical history, medications, family history, diseases, illnesses, conditions, surgeries, medical procedures, medical diagnostic tests, vital signs, lab results, associated healthcare providers, demographic information, allergies, responses to treatment, responses to medication, health insurance information, medical claims, medical costs, medical professional information, PCP information, healthcare facility information, or the like. The source information 220 may be processed by the management application 250 and stored in the system memory 215 as healthcare information 235 and/or healthcare expenditure information 235. Accordingly, the source information 220 may generally include any information capable of being used to provide healthcare information 235, healthcare expenditure information 240 and/or to generate a healthcare assessment (for example, claim efficiency) according to some embodiments described herein.

The management application 250 may include various modules, programs, applications, routines, functions, processes, or the like (“components”) to perform functions according to some embodiments described herein. In some embodiments, the management application 250 may include a patient claim component 255, a hospital component 260, a patient component 265, a trends component 270, and/or a comments component 275.

In some embodiments, the components 255-275 may be configured to access the source data 220, health information 235 and/or health expenditure information 240 as described according to some embodiments herein. The health information 235 and/or the health expenditure information 240 may be selected based on various factors, including, without limitation, a date range, a type of healthcare facility, financial thresholds, date of service, effective date (for instance, the date when a claim was processed and/or generated), geographic region, relationships between healthcare providers and/or healthcare professionals, or the like. In some embodiments, the components 255-275 may present the healthcare information 235, healthcare expenditure information 240 through a graphical user interface (GUI—information interface 280 or a report 285. In some embodiments, the GUI—information interface 280 may graphically present the healthcare information 235 and/or healthcare expenditure information 240 to a user, for instance, through a display operably connected to a client logic device 105. In some embodiments, the reports 285 may present the healthcare information 235 and/or healthcare expenditure information 240 in a report format for printing and/or viewing on a display operably connected to a client logic device 105. The healthcare information 235 and/or healthcare expenditure information 240 may be selected by the components 255-275 based on various selection factors, specified by the management application 250 and/or through user input 225. Non-limiting examples of selection factors include, without limitation, a date range, a type of healthcare facility, financial thresholds, date of service, effective date (for instance, the date when a claim was processed and/or generated), geographic region, or the like.

In some embodiments, the components 255-275 may be configured to provide healthcare information 235, healthcare expenditure information 240, and/or healthcare assessments 290 focused on various healthcare entities. For instance, the components 255-275 may be focused at a patient level and may provide healthcare information 235 and/or healthcare expenditure information 240 on a particular patient and/or a group of patients (for example, patients with certain demographic information and/or medical histories). In another instance, the components 255-275 may be focused at a healthcare professional level and may provide healthcare information 235 and/or healthcare expenditure information 240 on a particular medical professional in order to provide an analysis of the effectiveness and/or costs associated with a particular medical professional. For instance, the components 255-275 may be configured to provide healthcare information 235 and/or healthcare expenditure information 240 that may indicate the cost effectiveness of a particular PCP alone or in comparison with other PCPs. In this manner, the management application 250 may provide functions for comparing various healthcare entities and the cost effectiveness thereof.

The patient claim module 255 may be configured to provide information associated with medical claim expenditures (“medical claim expenditure information”). In some embodiments, the medical claim expenditure information may be associated with healthcare entities associated with the patient, such as a healthcare provider, a healthcare facility, or the like. In some embodiments, the medical claim expenditure information may be associated with a PCP who has provided healthcare to the patient. In some embodiments, the medical claim expenditures may indicate the most expensive claim records. In some embodiments, the medical claim expenditure information may be provided in reference to one or more healthcare entities, such as PCPs, healthcare facilities, geographic areas or regions (for instance, separate treatment “markets”). In a non-limiting example, the patient claim module 255 may be configured to provide medical claim expenditure information indicating the most expensive claim records in proportion to their number of PCPs from a treatment market (for instance, a particular healthcare facility in a particular city).

In some embodiments, the patient claim module 255 may be configured to provide medical claim expenditure information that includes the most expensive healthcare providers and/or medical claims. In some embodiments, the most expensive healthcare providers and/or medical claims may be associated with a list of PCPs grouped, for example, based on healthcare facilities, such as an out-patient facility or a medical office in a particular city.

In some embodiments, the patient claim module 255 may be configured to present information associated with medical procedures (“medical procedures information”), including the type of procedure, healthcare entity information, and procedure outcome. In some embodiments, the medical procedure information may include the most expensive procedures in a claim within a selected time range based on, for example, the date of service or the effective date. In some embodiments, the medical procedure information may include the expenditures associated with a particular medical procedure and/or medical procedures, such as the total cost of a particular procedure, average cost of a procedure, average cost of a procedure for a particular healthcare entity.

In some embodiments, the patient claim module 255 may be configured to present information associated with the most expensive procedures and/or patients based on a specialty procedure (“specialty information”). The specialty information may include the type of specialty procedure, associated healthcare entities, and expenditures associated therewith. In some embodiments, the patient claim module 255 may be configured to present information associated with patient medications (“patient medication information”). The patient medication information may include the type of medications as well as any costs associated therewith. In some embodiments, the patient medication information may include the most expensive medications in medical claims, for instance, over a specified duration and/or associated with a particular healthcare entity (for instance, a PCP). In some embodiments, the patient medication information may include patient claim information indicating a total cost associated with a particular medication and/or a medical claim.

In some embodiments, the patient claim module 255 may be configured to provide information associated with diagnostic tests (“diagnostic test information”). The diagnostic test information may include information associated with a particular diagnostic test (for example, ultrasound, echocardiographs (“echo studies”), or the like) for one or more healthcare entities. In some embodiments, the patient claim module 255 may include information associated with admissions (“admissions information”). The admissions information may generally include any information associated with the admission of a patient into a healthcare facility, include duration of admission, reason(s) for admission, in-patient/out-patient status, healthcare entity information (for example, PCP). In some embodiments, the patient claim module 255 may provide admissions information per healthcare entity, such as per PCP, healthcare facility, or the like. In some embodiments, the admissions information may include a patient-PCP relationship, number of hospital days for each admission, the number of admissions for a particular patient, admitting healthcare facility, diagnosis, insurance information, and treating physician, as well as admission history information (for example, re-admission information).

The hospital component 260 may be configured to provide information associated with patient hospitalizations (“hospitalization information”). In some embodiments, the hospitalization information may include admission type information (for instance, in-patient, out-patient, nursing home, or the like). In some embodiments, the admission information may include admission notes that may include admissions notes (for instance, notes provided by a doctor, physician assistant, nurse, and/or other attending healthcare professional), hospitalization date, hospitalization duration, as well as an admissions status, such as active, in-patient, or the like. In some embodiments, the hospitalization information may be configured as a chronological record of the hospitalization by a medical professional, such as a PCP.

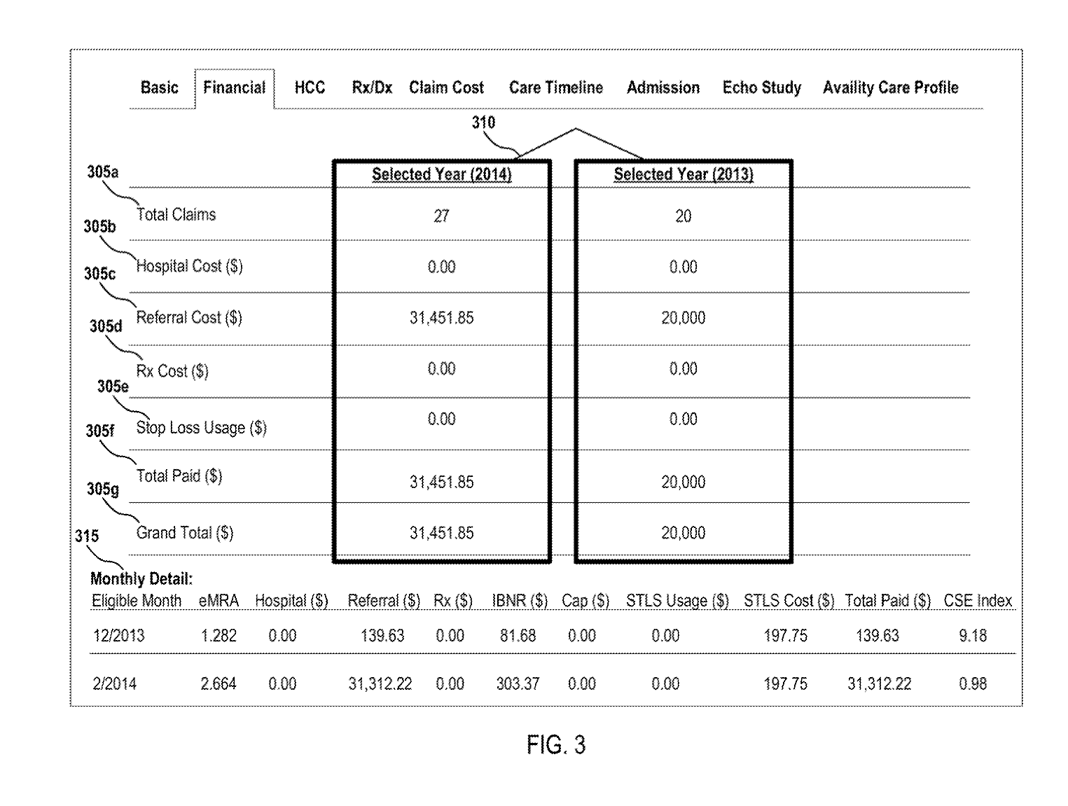

The patient component 265 may be configured to provide information associated with a patient (“patient information”). In some embodiments, the patient information may include basic patient demographic information, such as name, address, age, gender, identifying information (for instance, social security numbers), health insurance information, occupation, education, PCP, or the like, and/or historical information associated therewith (for instance, past name, address, health insurance, PCP, or the like). In some embodiments, the patient information may include financial information corresponding to costs associated with the patient. FIG. 3 depicts an illustrative financial information GUI for a patient according to some embodiments. As shown in FIG. 3, the financial information may include various financial information elements, such as total claims 305a, hospital cost 305b, referral cost 305c, prescription cost 305d, stop loss usage 305e, total paid 305f, and/or grand total 305g. In some embodiments, the grand total 305g may be configured to differentiate if the stop loss costs have been added or have not been added. In addition, the financial information may be presented in various comparative formats, such as side-by-side 310 and/or a time-based view 315 (for example, a month-based view). Additional financial information elements may include Internal Medicare Risk Adjustment (eMRA), incurred-but-not-reported (IBNR), and caps.

In some embodiments, the patient component 265 may be configured to provide information associated with CMS-HCC (“CMS-HCC information”) configured to show a base score of the patient based on patient age and gender and calculated using CMS-HCC models. In some embodiments, the CMS-HCC information may include a total score value calculated from a base score and a current problem list associated with a patient. The current problem list may be based on medical descriptions associated with HCC items, such as O/Metatastic Disease for HCC=8. In some embodiments, the CMS-HCC information may be associated with health insurer information and/or tracking applications.

In some embodiments, the patient component 265 may be configured to provide information associated with prescriptions and/or diagnoses (“prescription and diagnosis information”). For example, a user may select a patient and the prescription and diagnosis information may be presented on a prescription and/or diagnosis GUI. In some embodiments, the prescription and diagnosis information may include the current diagnosis list for a patient as well as any coding and/or scoring information, such as the International Classification of Diseases ICD(9) codes, HCC codes and scores. In some embodiments, the prescription and diagnosis information may include the current medications and/or medication history for a patient as well as any information associated therewith, such as prescription refill information, prescribing medical professional, or the like. In some embodiment, the prescription and diagnosis information may include cost information associated with any listed prescriptions and/or diagnoses, such as prescription costs, diagnoses cost estimates, costs incurred to-date, or the like.

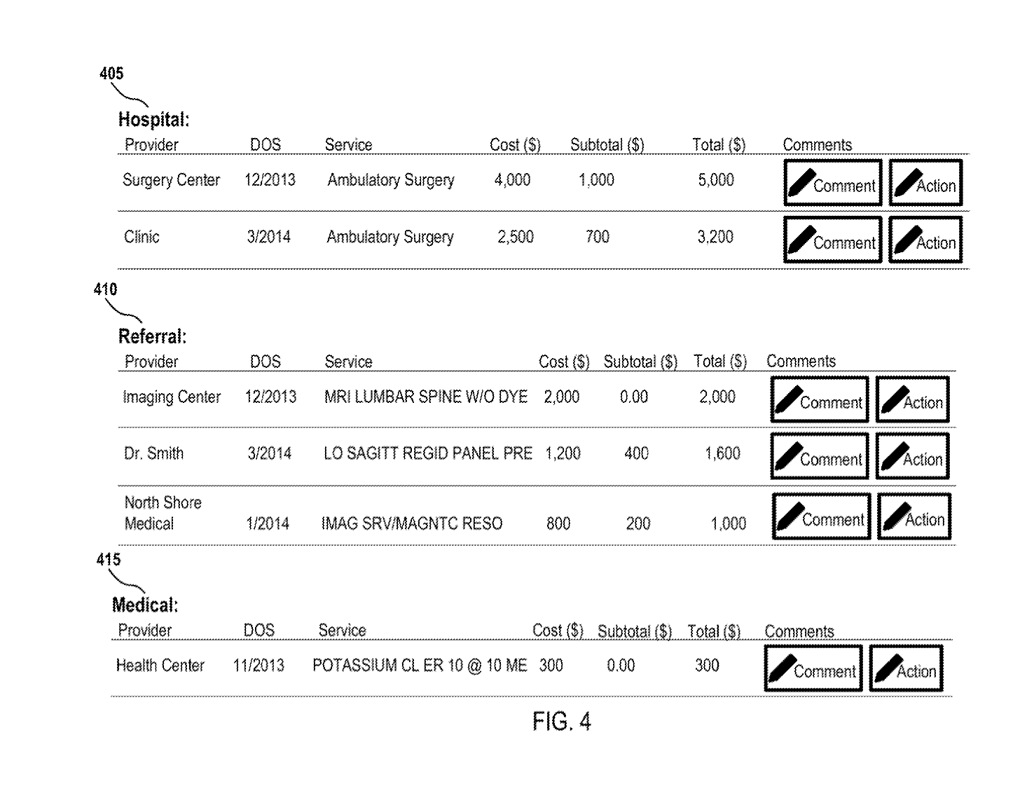

In some embodiments, the patient component 265 may be configured to provide information associated with a medical claim (“claim cost information”). The claim cost information may be organized based on various types, such as healthcare entities and/or healthcare information 235. For instance, the claim cost information may be organized based on a healthcare facility type, a referral type, a medication type, and any other type of healthcare entity and/or healthcare information 235 associated with the medical claim. In some embodiments, the types may be clustered based on healthcare entity, such as medical provider. In some embodiments, the claim cost information may be annotated with various details, including, without limitation, date of service, service description, and associated costs of the claim. FIG. 4 depicts an illustrative claim cost information GUI clustered based on hospital 405, referral 410, and medication 415 according to some embodiments.

In some embodiments, the patient component 265 may be configured to provide information associated with the a chronology of healthcare provided for a patient (“patient care timeline information”). In general, the patient care timeline information may provide a comprehensive set of healthcare information 235 and/or healthcare expenditure information 240 for a patient, spanning across diagnoses, healthcare facilities, and/or healthcare providers over a particular duration. In some embodiments, the patient care timeline information may be configured as a timeline of all services (for example, service types, claims, office visits, office referrals, diagnostic tests, procedures, diagnoses, medications, specialties, or the like) that a patient has been associated with.

The patient care timeline information may provide a GUI interface 280 and/or a report 285 that enables a user to track and analyze patient information beyond what is available using conventional technology, such as EMRs, EHRs, HIMS, or the like. In some embodiments, the patient care timeline information may be presented based on date of service, healthcare entity, service type, service, diagnosis, cost, comments/notes provided by a healthcare provider, or the like. In some embodiments, the patient care timeline information may be augmented by notes, comments, status information, or the like that may be added by a healthcare professional. In some embodiments, the patient care timeline information may be configured to provide costs associated with service, event, procedure, or the like, and/or any estimate associated therewith.

In some embodiments, the patient care timeline information may include patient admission history depicting the admission date, discharged date, the PCP, the hospital physician (medical doctor), the type of admission, the facility, the diagnosis, procedures, and/or a chronological admission narrative including details related to patient conditions. In some embodiments, the patient care timeline information may include diagnostic test study information providing information relating to diagnostic tests (or “studies”) for the patient, including date of service, diagnostic test type, test location, referring physician, diagnostic test technician, and any comments or notes provided by a medical professional.

The patient care timeline information provides multiple technological advantages. One non-limiting technological advantage includes allowing a medical professional, such as a PCP, to review all care provided to a patient by incorporating elements of healthcare information 235 and/or healthcare expenditure information 240, including, without limitation, internal referrals, diagnostic orders, claims data to review for hospitalizations, procedures, and diagnostic tests that a PCP would not be aware of using conventional technology. Another non-limiting technological advantage is that all of the patient care timeline information may be available at the point-of-care to assist a healthcare professional, such as a PCP, to be aware of the full spectrum of care associated with a patient and/or patients having similar demographic information and/or medical histories, as well as providing the medical professional with an awareness of the costs associated with any past and/or potential future medical care.

In some embodiments, the patient component 265 may include various auxiliary data functions, including the ability to access health insurer data and applications (for example, Humana® Availity®) and to transmit (for example, email) information directly to other entities, such as other healthcare providers, in a format that provides a comprehensive view of a patient record without having to access the management application 250.

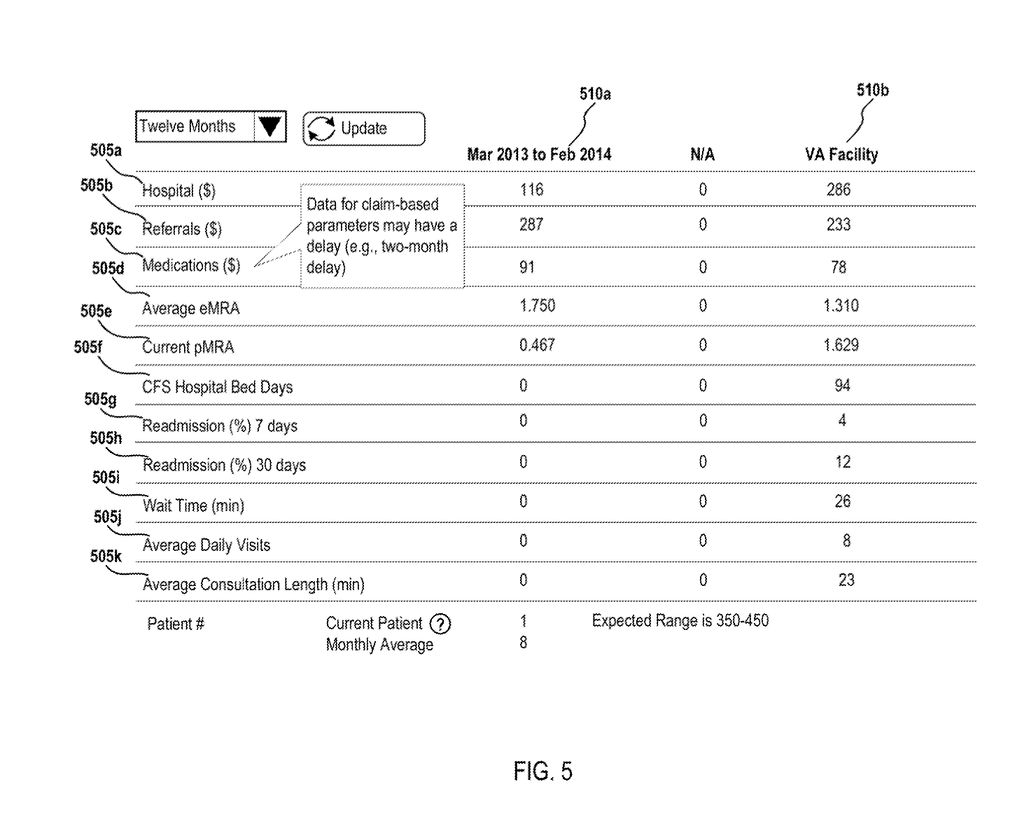

The trends component 270 may be configured to analyze the service tendencies of various healthcare providers, such as PCP, over a specified duration. In some embodiments, the information provided by the trends component 270 may be used to compare and analyze the performance of healthcare providers, healthcare facilities, regions, markets, treatment plans, treatment strategies, or the like. FIG. 5 depicts an illustrative trend GUI according to some embodiments. As shown in FIG. 5, various trend metrics, which may be configured as healthcare information and/or healthcare expenditure information, may include hospital costs 505a, referral costs 505b, medication costs 505c, average eMRA 505d, average pMRA 505e, hospital bed days 505f, readmission rate (7 days) 505g, readmission rate (30 days) 505h, wait times 505i, average daily visits 505j, average consultation length 505k. Trends may be provided over a particular duration 510a, for a particular facility 510b, a particular medical professional (not shown), a particular diagnosis (not shown), and/or any other type of trend that may be configured according to some embodiments.

In some embodiments, the hospital costs 505a may include the average cost of hospital claims, for instance, in per-member per-month (PMPM) format for the selected physicians panel and selected period of time, compared within a healthcare facility and/or market. In some embodiments, the referral costs 505b may include the average cost of referral claims in PMPM format for the selected physicians panel and selected period of time, compared within a healthcare facility and/or market. In some embodiments, the medication costs 505c may include the average cost of medication claims in PMPM format for the selected physicians panel and selected period of time, compared within a healthcare facility and/or market. In some embodiments, the average eMRA 505d may include a calculation of eMRA based on a patient problem list from an internal EHR System. In some embodiments, the average pMRA 505e may include information calculated from the a health insurer application (for example, Humana® ProStar®) based on CMS accepted codes. In some embodiments, the hospital bed days 505f may include the total number of bed days for a period of time by healthcare provider, healthcare facility, and/or market by pulling data from an internal hospital data system. In some embodiments, the readmission rate (7 days) 505g may include the percentage of patients that have been readmitted before 7 days after the patient has been discharged from the healthcare facility. In some embodiments, the readmission rate (30 days) 505h may include the percentage of patients that have been readmitted before 30 days after the patient has been discharged from the healthcare facility. In some embodiments, the wait times 505i may include the average wait time for each patient visit. In some embodiments, the average daily visits 505j may include the daily visit of patients per healthcare provider, healthcare facility, and/or market. In some embodiments, the average consultation length 505k may include the average amount of time that the healthcare provider spent with the patient.

In some embodiments, the trends component 270 may be configured to determine the total number of patients that have been assigned to the healthcare provider during a particular duration and the expected range of patients estimated to be assigned to the healthcare professional during the particular duration.

In some embodiments, the trend component 270 may be configured to provide a graphical representation of any trend metric for a healthcare entity over a specified duration. For example, the wait times 505i for two healthcare facilities may be plotted on the same graph for a visual representation of the wait time differences between the two healthcare facilities. In some embodiments, the plotted graphs may include measured values (for example, wait times as measured by a healthcare facility) and feedback values (for example, wait times as entered by patients through the feedback element). In some embodiments, each plot on a graph may be selectable to provide further information associated therewith. For example, for a wait time graph, a plot for a wait time value (for example, 40 minutes) on a particular time (for example, Jan. 1, 2015 at 12:00 pm) may include information such as attending physician, number of medical staff on duty, number of patients at medical facility, or the like.

In some embodiments, the trends component 270 may include a feedback component configured to receive feedback from patients and/or healthcare providers. In some embodiments, the feedback component may be configured to capture patients' feedback with their experience with a particular healthcare entity, procedure, and/or other aspect of service provided by a healthcare entity. In some embodiments, the feedback may include comments and a score element, for instance, a score element that ranges from 1 to 10, in which 10 represents the “highest” service level provided. In some embodiments, the feedback may include specific a set of predetermined variables, including total surveys (for example, the total of patients that have completed the survey during a period of time by healthcare professional, healthcare facility, and/or market), wait time, communication (for example, a value indicating the communication skills of a healthcare professional), recommendation (for example, a value indicating the probability that the patient will recommend the healthcare professional and/or healthcare facility). In some embodiments, the feedback component may be configured to determine a net promoter score configured to calculate the percentage between a high (good) score and a low (poor) score. In addition, the feedback component may be configured to receive feedback for other healthcare personnel or characteristics of a healthcare facility, such as medical staff, front desk personnel, cleanliness, appearance, transportation experience, and overall recommendation score, and comments. In some embodiments, the feedback may be stored as healthcare information 235.

In some embodiments, the trend component 270 may be configured to generate a healthcare assessment in the form of information associated with efficiency (“efficiency information”). In some embodiments, the efficiency information may include medical claim efficiency. In some embodiments, claim efficiency may be characterized by the following relationship:

efficiency=(Cost/HCC) vs. HCC. (1)

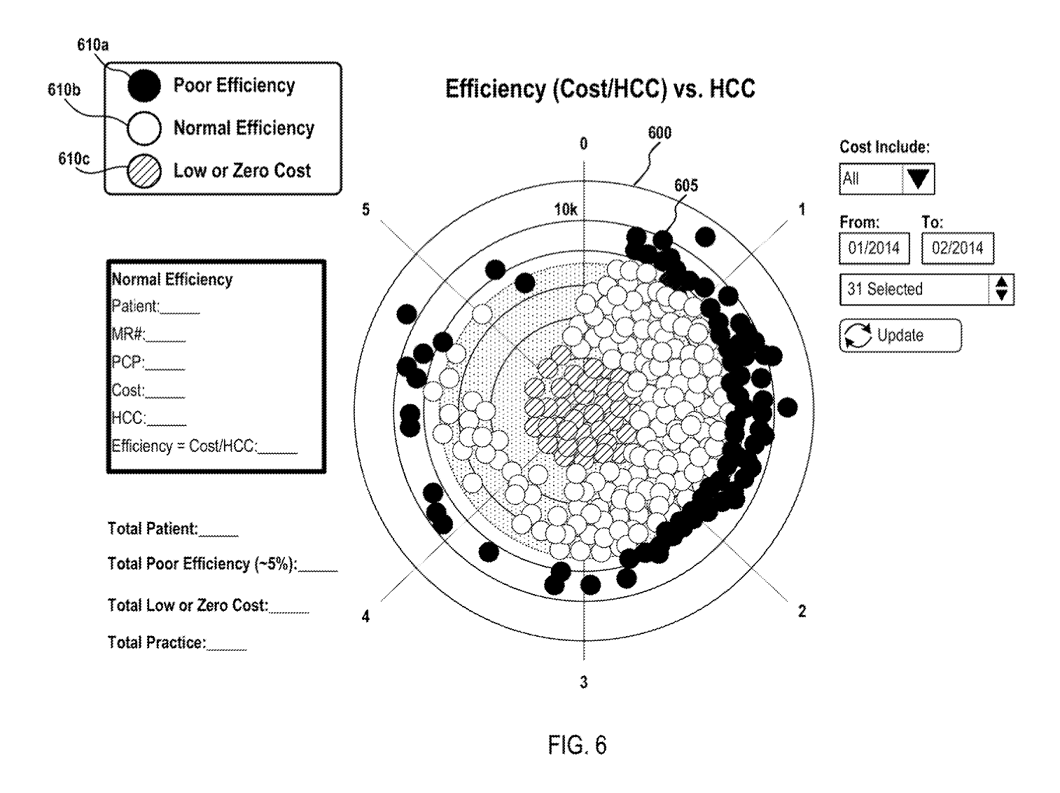

The relationship provided in (1), above, may be defined by the patient claim costs divided by the patient's total HCC distributed against the patient's HCC. In some embodiments, the efficiency information may be graphed, for example, using a polar chart (an “efficiency fingerprint”). FIG. 6 depicts a polar chart of efficiency information according to an embodiment. As shown in FIG. 6, a efficiency polar chart 600 may present efficiency plots 605 for each individual patient. Although there are multiple efficiency plots 605 depicted in FIG. 6, only one is referenced to simplify the figure. The efficiency plots 605 may be categorized, for example, into poor efficiency 610a, normal efficiency 610b, and low or zero cost (“high efficiency”) 610c. In some embodiments, a user may select a category 610a-c to only show efficiency plots 605 within the category. As depicted in FIG. 6, efficiency plots 605 near the center of the efficiency polar chart 600 are the most efficient and the efficiency plots at the outer edge are the least efficient.

In some embodiments, selection of an efficiency plot 605 may provide access to any healthcare information 235 and/or healthcare expenditure information 240 associated with the efficiency plot, such as a patient, a healthcare provider, a healthcare facility, a diagnosis, or the like. For example, selection of an efficiency plot 605 may provide access to the patient care timeline information associated therewith. In this manner, a user may have a visual representation of the efficiency of medical claims and may have access to all information associated therewith.

In some embodiments, the trend component 270 may be configured to generate trend information associated with the efficiency information (“efficiency trend information”). For example, the trend component 270 may be configured to analyze the efficiency information to determine if there are any trends associated therewith. For example, whether a particular healthcare provider, healthcare facility, diagnosis, or the like is associated with high efficiency values, or vice versa. In another example, the trend component 270 may determine various relationships (for example, “learn” trends) between the healthcare information 235 and/or the healthcare expenditure information 240 and the efficiency information. For instance, the trend component 270 may learn that certain treatment paths for certain patients (for example, with certain demographic information and/or medical histories) are less efficient than other treatment paths for certain diagnoses. In another instance, the trend component 270 may learn that certain treatment paths are more efficient at certain healthcare facilities than at other healthcare facilities. In such an example, the trend component 270 may provide a healthcare assessment advising that a certain treatment path for a particular diagnosis should be chosen based on the medical history of a patient and/or the particular healthcare facility that will be treating the patient.

FIG. 7 depicts a block diagram of exemplary internal hardware that may be used to contain or implement the various computer processes and systems as discussed above. A bus 700 serves as the main information highway interconnecting the other illustrated components of the hardware. CPU 705 is the central processing unit of the system, performing calculations and logic operations required to execute a program. CPU 705, alone or in conjunction with one or more of the other elements disclosed in FIG. 4, is an exemplary processing device, computing device or processor as such terms are used within this disclosure. Read only memory (ROM) 730 and random access memory (RAM) 735 constitute exemplary memory devices.

A controller 720 interfaces with one or more optional memory devices 725 to the system bus 700. These memory devices 725 may include, for example, an external or internal DVD drive, a CD ROM drive, a hard drive, flash memory, a USB drive or the like. As indicated previously, these various drives and controllers are optional devices. Additionally, the memory devices 725 may be configured to include individual files for storing any software modules or instructions, auxiliary data, common files for storing groups of results or auxiliary, or one or more databases for storing the result information, auxiliary data, and related information as discussed above. For example, the memory devices 725 may be configured to store healthcare information 235, healthcare expenditure information 240 and/or contained in the data stores 115.

Program instructions, software or interactive modules for performing any of the functional steps associated with the analysis of judicial decision making as described above may be stored in the ROM 730 and/or the RAM 735. Optionally, the program instructions may be stored on a tangible computer-readable medium such as a compact disk, a digital disk, flash memory, a memory card, a USB drive, an optical disc storage medium, such as a Blu-ray™ disc, and/or other recording medium.

An optional display interface 730 may permit information from the bus 700 to be displayed on the display 735 in audio, visual, graphic or alphanumeric format. The information may include information related to a current job ticket and associated tasks. Communication with external devices may occur using various communication ports 740. An exemplary communication port 740 may be attached to a communications network, such as the Internet or a local area network.

The hardware may also include an interface 745 which allows for receipt of data from input devices such as a keyboard 750 or other input device 755 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by some embodiments described herein.

What is claimed is:

1. A healthcare management system comprising:
a processor; and
a non-transitory, computer-readable storage medium in operable communication with the processor, wherein the computer-readable storage medium contains one or more programming instructions that, when executed, cause the processor to:
access source information from at least one data source;
generate healthcare information and healthcare expenditure information from the source information; and
generate at least one healthcare assessment based on the healthcare information and the healthcare expenditure information, the healthcare assessment being configured to indicate a cost efficiency of at least one item of healthcare information.

2. The system of claim 1, wherein the source information comprises at least one of a healthcare information and management systems, an electronic medical record system, a radiology information system, a picture archiving and communications system, a Medicaid Management Information System, a health insurance provider system, a health information library, and a third-party database.

3. The system of claim 1, wherein the healthcare information comprises at least one of age, gender, weight, height, a medication, a medical procedure, an occupation, a past medical condition, a current medical condition, a family history, a patient description of health condition, a healthcare professional description of health condition, a symptom, medical survey information, a medical claims, a medical score, healthcare professional information, a primary care physician, health insurance information, and health care facility information.

4. The system of claim 1, wherein the healthcare assessment comprises at least one of a valuation, an appraisal, an evaluation, an estimation, a ranking, a measurement, and a calculation.

5. The system of claim 1, wherein the healthcare assessment is configured to indicate a cost efficiency of at least one medical claim.

6. The system of claim 1, wherein the computer-readable storage medium contains one or more programming instructions that, when executed, further cause the processor to generate a trend for at least one healthcare provider based on the healthcare information and the healthcare expenditures information, the trend being configured to indicate the service tendencies of the at least one healthcare provider.

7. The system of claim 6, wherein the service tendencies comprise medical claim efficiency.

8. The system of claim 6, wherein the trend comprises a polar chart configured to indicate a medical claim efficiency of the at least one healthcare provider.

9. A computer-implemented method for generating at least one healthcare assessment, the method comprising, by a processor:
accessing source information from at least one data source;
generating healthcare information and healthcare expenditure information from the source information; and
generating the at least one healthcare assessment based on the healthcare information and the healthcare expenditure information, the healthcare assessment being configured to indicate a cost efficiency of at least one item of healthcare information.

10. The method of claim 9, wherein the source information comprises at least one of a healthcare information and management system, an electronic medical record system, a radiology information system, a picture archiving and communications system, a Medicaid Management Information System, a health insurance provider system, a health information library, and a third-party database.

11. The method of claim 9, wherein the healthcare information comprises at least one of age, gender, weight, height, a medication, a medical procedure, an occupation, a past medical condition, a current medical condition, a family history, a patient description of health condition, a healthcare professional description of health condition, a symptom, medical survey information, a medical claims, a medical score, healthcare professional information, a primary care physician, health insurance information, and health care facility information.

12. The method of claim 9, wherein the healthcare assessment comprises at least one of a valuation, an appraisal, an evaluation, an estimation, a ranking, a measurement, and a calculation.

13. The method of claim 9, wherein the healthcare assessment is configured to indicate a cost efficiency of at least one medical claim.

14. The method of claim 9, wherein the computer-readable storage medium contains one or more programming instructions that, when executed, further cause the processor to generate a trend for at least one healthcare provider based on the healthcare information and the healthcare expenditures information, the trend being configured to indicate the service tendencies of the at least one healthcare provider.

15. The method of claim 14, wherein the service tendencies comprise medical claim efficiency.

16. The method of claim 14, wherein the trend comprises a polar chart configured to indicate a medical claim efficiency of the at least one healthcare provider.

17. A healthcare management system comprising:
a processor; and
a non-transitory, computer-readable storage medium in operable communication with the processor, wherein the computer-readable storage medium contains one or more programming instructions that, when executed, cause the processor to:
access source information from at least one data source;
generate healthcare information and healthcare expenditure information from the source information; and
generate a patient care timeline interface configured to present healthcare information and healthcare expenditure information associated with a patient for a particular duration.

18. The system of claim 19, wherein the patient care timeline interface includes at least one of a patient admission history, a medication history, a diagnosis, a healthcare facility, a healthcare professional, a diagnostic test study, a referral, hospitalization information, claims data, and a medical procedure.

19. The system of claim 19, wherein the patient care timeline interface is configured to present healthcare information and healthcare expenditure information from a plurality of healthcare providers.

20. The system of claim 19, wherein the patient care timeline interface comprises a chronology of healthcare provided to a patient and associated costs of the healthcare.
